(19) United States
(12) Patent Application Publication
(10) Pub. No.: US 2020/0402031 A1
(43) Pub. Date: Dec. 24, 2020

(54) SYSTEMS AND METHODS FOR GENERATING SMART CONTRACTS TO MANAGE ESCROW TRANSACTIONS

(71) Applicant: Escaroo Limited, St. Clement (JE)

(72) Inventors: Frank Joseph Pira, St. Clement (JE); Edmund Paul Zynda, III, Las Vegas, NV (US)

(21) Appl. No.: 16/449,136

(22) Filed: Jun. 21, 2019

(51) Int. Cl. G06Q 20/10; G06Q 20/38

(52) U.S. Cl. CPC G06Q 20/108; G06Q 20/389

(57) ABSTRACT

The present disclosure relates to systems and methods for configuring, creating, and deploying smart contracts to facilitate managing and execution of escrow transactions. Embodiments provide for receiving information about an escrow transaction that includes at least one term required to be met for digital property, provided by a funding party, to be distributed to a performing party. Embodiments also include generating a transaction smart contract based on the transaction information. The transaction smart contract is configured to hold the digital property until a triggering event is detected, at which time the transaction smart contract disposes of the digital property. Embodiments further include causing the transaction smart contract to be funded with the digital property, and determining that the triggering event has occurred. The transaction smart contract is then triggered to dispose of the digital property based on the triggering event.

### TECHNICAL FIELD

The present subject matter is directed generally to smart contracts, and more particularly to systems for generating escrow-based smart contracts.

### BACKGROUND

Traditionally, escrow-based transactions involve participants surrendering funds to an escrow service. The escrow service generally pools the participants' funds into a single account, whose accounting and distributions are overseen by a fund manager. This traditional model, however, can present challenges for the fund manager, as accounting for the pooled account can be problematic, especially considering that some pooled accounts may include hundreds or thousands of accounts and/or escrow transactions.

Some automated solutions to the challenges of the traditional escrow model have been proposed. One particular solution employs a digital wallet to hold the escrow funds. However, such a solution merely emulates the traditional escrow funding model, albeit using a digital wallet. Thus, in this solution, a single pooled digital wallet may be used, but this results in the same challenges as the traditional escrow model of using a single bank account. Moreover, this solution, and indeed the state of the art in general, does not have a mechanism to separate the pooled escrow accounts. Thus, existing systems for escrow-based transactions are not able to handle the creation and management of single accounts for each individual escrow fund/transaction.

### SUMMARY

The present application relates to systems and methods for configuring, creating, and deploying smart contracts to facilitate managing and execution of escrow transactions. In embodiments, at least one interface may be provided to allow users to provide information about escrow transactions. The escrow transaction information may be used to configure and create a transaction smart contract. The transaction smart contract may be deployed and executed, and subsequently funded with at least one digital property. Upon occurrence of a triggering event, the transaction smart contract may be triggered to dispose of the at least one digital property. In aspects, the triggering event may include performance of the terms of the escrow transaction, failure to meet the terms of the escrow transaction, contesting of the escrow transaction, expiration of a timer, etc. Disposing of the at least one digital property may include returning the at least one digital property to the funding party (e.g., returning to buyer when the terms of the transaction are not met), distributing the at least one digital property to the appropriate party (e.g., the seller, the service provider, etc.), and/or forwarding the at least one digital property to a mediator (e.g., when the transaction is disputed or contested).

In aspects, the transaction smart contracts of embodiments may be implemented, deployed, and/or executed using blockchain technology. In this sense, aspects of the present disclosure provide for a mechanism for configuring, creating, and deploying publicly hosted but privately managed, escrow based smart contracts. Systems implemented in accordance with aspects of the present disclosure may be considered software as a service (SAAS) systems. As noted above, escrow-based transaction smart contracts of embodiments may securely hold and distribute transaction funds, such as digital property (e.g., crypto assets, digitized documents, etc.), allowing parties involved in the escrow transaction to buy and/or sell items and/or services in a secure blockchain-based escrow transaction.

In aspects, a service may be created that produces individual and unique escrow based keyless smart contracts for a transaction, in which the smart contracts may securely hold and distribute the funds of the transaction according to the terms set within the transaction. The transaction smart contract, configured using transaction information, may be configured to release the transaction funds only to parties involved in the transaction (e.g., seller, buyer, mediator, etc.), and only when all transaction parties are satisfied that the terms of the transaction agreement have been met. In aspects, if any of the transaction parties is dissatisfied with the outcome of the transaction, then the smart contract may not release the funds until all terms have been met satisfactorily, or may forward the funds to a mediator for subsequent disposition.

In some embodiments, the transaction smart contracts may be posted to a publicly hosted blockchain, and in these cases, no single entity may have the keys to the unique transaction smart contract. This unique approach ensures that there is no need for third party oversight, as the transaction parties have sole control of the transaction. This may create a true trust-less system. In aspects, transaction funds may never be pooled together in a single wallet or single smart contract, which removes the need for fund manager oversight.

As used herein, an escrow transaction may refer to a transaction involving at least a first party and a second party, in which the first party provides funds to be held in escrow until an event occurs. The event may be performance of the terms of the transaction, in which case the escrow funds may be released to the second party, or may be failure to meet the terms of the transaction, in which case the funds may be returned to the first party. In aspects, funds may refer to digital property. The second party may be referred to herein as the performing party, and the first party may be referred to herein as the funding party. It is also noted at this point that the escrow transaction may involve more than two parties, even though the discussion herein focuses on a transaction involving a first party and a second party. In a case where more than two parties are involved in the escrow transaction, any combination of the parties may be the funding party providing the funding of the smart contract, and any combination of the parties may be the performing party performing (e.g., seller, service provider, etc.). In some aspects, the escrow transaction may also involve a third party agent. The third party agent may represent any or all of the transaction parties. The role of the third-party agent may include determining when performance of the terms of the escrow transaction has been or has not been met. Based on that determination, the third party agent may cause the transaction smart contract to dispose of the funds.

As used herein, digital property may refer to any digital representation of property. For example, digital property may refer to digital currency, tokens, tokenized representations of assets (e.g., physical and/or digital asserts), etc. In aspects, digital property may also refer to rights to property, and/or access to property that may be provided in digital form. For example, digital property may include crypto currency, digital documents, files, cryptographic keys, domains, programs, accounts, rights to information, and/or any other digitized asset or property that may be obtained, provided, and/or accessed digitally. It is noted that as used herein, funds may refer to digital property. In some aspects, digital property may refer to any digital asset which a smart contract may be configured to hold.

In one particular embodiment, a method includes receiving information about an escrow transaction, the escrow transaction involving a first party and a second party, and the first party providing at least one digital property. The escrow transaction includes at least one term required to be met for the at least one digital property to be distributed to the second party. The method also includes generating a transaction smart contract based on the information about the escrow transaction. The transaction smart contract is configured to hold the at least one digital property, and to dispose of the at least one digital property based on a triggering event. The method further includes causing the transaction smart contract to be funded, which includes providing the at least one digital property to the transaction smart contract for holding, determining that the triggering event has occurred, and triggering the transaction smart contract to dispose of the at least one digital property based on the triggering event.

In another embodiment, a system may be provided. The system may include a transaction manager configured to receive information about an escrow transaction, the escrow transaction involving a first party and a second party, and the first party providing at least one digital property. The escrow transaction includes at least one term required to be met for the at least one digital property to be distributed to the second party. The transaction manager is further configured to cause the transaction smart contract to be funded, which includes providing the at least one digital property to the transaction smart contract for holding, to determine that a triggering event has occurred, and to trigger the transaction smart contract to dispose of the at least one digital property based on the triggering event. The system also includes a smart contract generator configured to configure, based on the information about the escrow transaction, a transaction smart contract to hold the at least one digital property, and to dispose of the at least one digital property based on the triggering event.

In yet another embodiment, a computer-based tool may be provided. The computer-based tool may include non-transitory computer readable media having stored thereon computer code which, when executed by a processor, causes a computing device to perform operations that include receiving information about an escrow transaction, the escrow transaction involving a first party and a second party, and the first party providing at least one digital property. The escrow transaction includes at least one term required to be met for the at least one digital property to be distributed to the second party. The operations also include generating a transaction smart contract based on the information about the escrow transaction. The transaction smart contract is configured to hold the at least one digital property, and to dispose of the at least one digital property based on a triggering event. The operations further include causing the transaction smart contract to be funded, which includes providing the at least one digital property to the transaction smart contract for holding, determining that the triggering event has occurred, and triggering the transaction smart contract to dispose of the at least one digital property based on the triggering event.

The foregoing broadly outlines the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 shows a system configured to perform operations in accordance with embodiments of the present disclosure;

FIG. 2 shows a flow diagram illustrating functionality of a transaction manager in accordance with aspects of the present disclosure;

FIG. 3 shows a flow diagram illustrating functionality of a smart contract generator in accordance with aspects of the present disclosure; and

FIG. 4 shows an operational flow diagram illustrating example blocks executed to implement aspects of the present disclosure.

### DETAILED DESCRIPTION

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

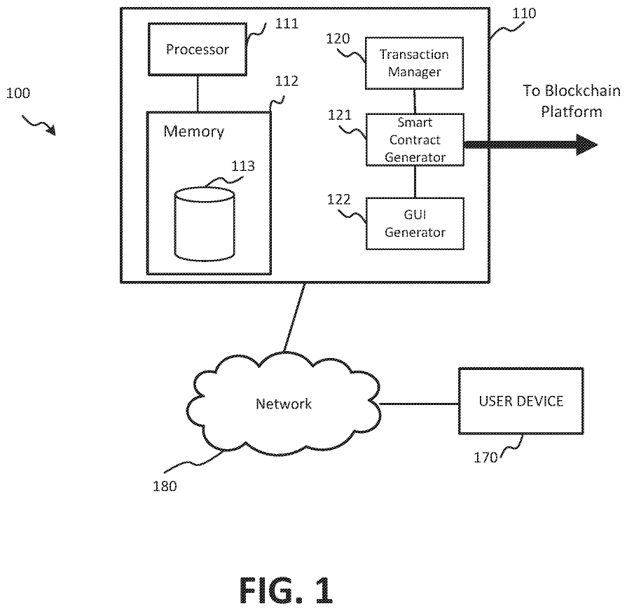

FIG. 1 is a block diagram of an exemplary system 100 configured with capabilities and functionality for configuring, creating, and deploying smart contracts to facilitate managing and execution of escrow transactions. System 100 may be implemented as SAAS solution system for providing an interface that may allow its users the ability to create and launch a publicly hosted but privately managed, escrow based smart contract. Escrow based smart contracts may be configured to securely hold and distribute cryptographic based assets, thereby allowing all parties involved to buy or sell items or service in a secure blockchain based escrow transaction. Because embodiments may allow for the smart contract to be posted on a publicly hosted blockchain, embodiments may provide that no single entity may have possession of the keys to the unique escrow smart contract. This unique approach may remove the need for third party oversight, as the parties involved in the transaction are controllers of said transaction, creating a true peer-to-peer trust-less system. Embodiments may be implemented such that funds may never be pooled together in a single wallet or smart contract, removing the need for fund manager oversight.

System 100 includes server 110, user device 170, and network 180. These components, and their individual components, may cooperatively operate to provide functionality in accordance with the discussion herein. In some aspects, the functionality of system 100 may be provided, at least in part, as a web-based program, as a stand-alone application (e.g., mobile, and/or desktop-based), as a cloud-based application, as an application programming interface (API), etc. For example, user device may be used by a user to provide transaction information about an escrow transaction involving a first party and a second party. The transaction information may be communicated, via network 180, to server 110. Server 110 may include functionality to generate, based on the transaction information, a transaction smart contract to manage the transaction. The transaction smart contract may be deployed to and executed in a blockchain. The first party may then fund the transaction smart contract with at least one digital property. Upon occurrence of a triggering event, the transaction smart contract may be triggered to dispose of the at least one digital property. In aspects, the blockchain technology used to deploy and execute the transaction smart contract may include using a blockchain platform such as Ethereum, EOS, XRP, Bitcoin, and/or any other blockchain platform. Those of skill in the art will understand that systems implemented in accordance with aspects of the present disclosure may be blockchain-agnostic, and any discussion of a particular blockchain example is made for illustrative purposes, and should not be construed as limiting in any way.

Although the disclosure that follows focuses on an example of an escrow transaction involving a buyer and a seller, it will be appreciated that the disclosure herein is equally applicable in any other escrow-based transaction. For example, the disclosure herein may be applicable to systems used for transactions involving peer-to-peer escrow transactions, business-to-customer transactions, business-to-business transactions, import or domestic letters of credit transactions, export letters of credit transactions, standby letters of credit, etc. As such, the discussion herein with respect to buyer and seller transactions should not be construed as limiting in any way.

The functional blocks, and components thereof, of system 100 of embodiments of the present invention may be implemented using processors, electronic devices, hardware devices, electronic components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally or alternatively, when implemented in software, one or more of the functional blocks, or some portion thereof, may comprise code segments operable upon a processor to provide logic for preforming the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such aspects, the functionality of each respective component may be aggregated from the functionality of multiple modules residing in a single, or in multiple devices.

Network 180 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc., and may facilitate communications between server 110 and user device 170, and/or communications between server 110 and a blockchain platform to which the smart contracts may be deployed.

User device 170 may be configured to provide an interface to facilitate user input and output operations in accordance with aspects of the present disclosure. The interface may include a graphical user interface (GUI). In aspects, the GUI may be configured and generated by GUI generator 122 of server 110, discussed in more detail below. In embodiments, a user may use the GUI to provide input transaction information about an escrow transaction, such as buyer and/or seller information, contact information, details about the transaction, type and/or amount of funds involved in the transactions, terms of the transaction, digital wallet addresses for buyer and/or seller, etc. The GUI configured by GUI generator 122 and provided to a user by user device 170 may also be configured to receive further inputs from a user indicating agreement/disagreement with the terms of a particular escrow transaction (e.g., a second party agreeing/disagreeing with the information/terms of the transaction provided by a first party), funding a smart contract by providing funding address and/or authorization to fund, and/or indicating that a particular event has occurred (e.g., performance or failure to perform the terms of the transaction) or contesting the escrow transaction. In embodiments, the GUI configured by GUI generator 122 and provided to a user may be configured to provide outputs to the user that may include invitations to review and/or join an escrow transaction initiated by a first party, information about the proposed transaction (e.g., with which the user may agree/disagree), information about a smart contract generated and deployed for the escrow transaction (e.g., an address, such as a block chain address, associated with the smart contract, for funding of the smart contract, and/or GUI controls for indicating that at least one particular term of the escrow transaction or all terms of the escrow transaction have or have not been met. Further details of these functions of user device 170 are described in more detail below.

In aspects, end user device 180 may be implemented as a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof.

Server 110 may be configured to receive transaction information about an escrow transaction involving a first party and a second party, to generate, based on the transaction information, a transaction smart contract to manage the transaction, to deploy the transaction smart contract to a blockchain, to cause the transaction smart contract to be funded with at least one digital property, and to, upon occurrence of a triggering event, trigger the transaction smart contract to dispose of the at least one digital property. This functionality of server 110 may be provided by the cooperative operation of various components of server 110, as will be described in more detail below. Although FIG. 1 shows a single server 110, it will be appreciated that server 110 and its individual functional blocks may be implemented as a single device or may be distributed over multiple devices having their own processing resources, whose aggregate functionality may be configured to perform operations in accordance with the present disclosure. In some embodiments, server 110 may be implemented, wholly or in part, on an on-site system, or on a cloud-based system.

As shown in FIG. 1, server 110 includes processor 111, memory 112, database 113, transaction manager 120, smart contract generator 121, and GUI generator 122. It is noted that the various components of server 110 are illustrated as single and separate components in FIG. 1. However, this illustration is made for illustrative purposes only and not intended to be limiting in any way. It will be appreciated that each of the various components of server 110 may be a single component (e.g., a single application, server module, etc.), may be functional components of a same component, or the functionality may be distributed over multiple devices/components. In such aspects, the functionality of each respective component may be aggregated from the functionality of multiple modules residing in a single, or in multiple devices.

In some aspects, processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some aspects, implementations of processor 111 may comprise code segments (e.g., software, firmware, and/or hardware logic) executable in hardware, such as a processor, to perform the tasks and functions described herein. In yet other aspects, processor 111 may be implemented as a combination of hardware and software. Processor 111 may be communicatively coupled to memory 112.

Memory 112 may comprise read only memory (ROM) devices, random access memory (RAM) devices, one or more hard disk drives (HDDs), flash memory devices, solid state drives (SSDs), other devices configured to store data in a persistent or non-persistent state, network memory, cloud memory, local memory, or a combination of different memory devices. Memory 112 may store instructions that, when executed by processor 111, cause processor 111 to perform operations in accordance with the present disclosure.

In aspects, memory 112 may also be configured to facilitate storage operations. For example, memory 112 may comprise database 113 for storing escrow transaction information (e.g., parties involved, contact information, details about the transaction, wallet addresses of the transaction parties, terms of the transaction, etc.), timer information (e.g., for determining an expiration of the smart contract), smart contract templates, generated smart contracts, smart contract addresses, analytics data, user preferences, etc., which system 100 may use to provide the features discussed herein. Database 113 may be integrated into memory 112, or may be provided as a separate module. In some aspects, database 113 may be a single database, or may be a distributed database implemented over a plurality of database modules. In some embodiments, database 113 may be provided as a module external to server 110.

GUI generator 122 may be configured to configure and generate a GUI for facilitating input and output operations from/to a user. For example, as noted above, a GUI may be generated by GUI generator 122 and provided to user device 170 for presentation to a user. The GUI may be configured to include various GUI controls for allowing the user to input information, such as information related to the escrow transaction, or outputting information to the user, such as information related to the transaction smart contract. In aspects, the information related to the escrow transaction may include information about the parties to the escrow transaction (e.g., number of parties and roles of each party, such as buyer and/or seller), contact information about the transaction parties (e.g., email addresses, shipping information, etc.), terms of the escrow transaction (e.g., product or service being sold/bought, events or activities determining performance non-performance of the transaction such as a product or service received or not received within a particular amount of time, etc.), type and/or amount of funds involved in the escrow transaction (e.g., crypto currency, digital document, cryptographic key, etc.), digital wallet addresses for the transaction parties, etc. In essence, any information related to the escrow transaction may be input by the user using the GUI. The output information presented to the user may include information about the transaction smart contract created to support the escrow transaction. This information may include an address associated with the transaction smart contract. This address may be used to fund the smart contract with the funds.

In some embodiments, the GUI may also include GUI controls for controlling various aspects of the process. For example, GUI controls may be provided for logging into the system, initiating the escrow transaction, inviting a second party to the escrow transaction, agreeing or disagreeing with terms of the escrow transaction, proposing new and/or revised transaction terms, authorizing funding of the transaction smart contract, acknowledging performance of terms (e.g., acknowledging or notifying receipt of product, services, etc.) of the escrow transaction, etc. It is noted that the user inputting information and receiving the output information may include any of the parties to the escrow transaction, a third party agent for either or all of the parties to the transaction, etc.

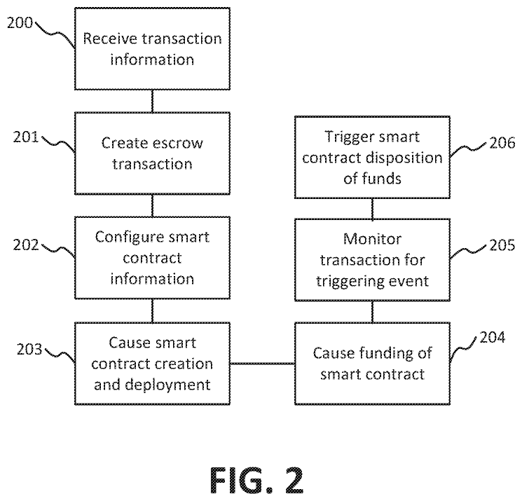

Transaction manager 120 may be configured to provide functionality to receive, analyze, and/or compile transaction information about an escrow transaction, to create the escrow transaction, to configure, launch, and/or execute, in cooperation with smart contract generator 121, a transaction smart contract to support the escrow transaction, to fund the transaction smart contract, and/or to monitor and manage the escrow transaction and operations of the transaction smart contract. The functionality of transaction manager 120 will now be discussed with respect to the block diagram illustrated in FIG. 2. FIG. 2 shows a flow diagram illustrating functionality of transaction manager 120 in accordance with aspects of the present disclosure.

At block 200, information about an escrow transaction is received. In aspects, receiving the transaction information may include receiving input information from a user via a GUI generated by GUI generator 122 and presented to the user via user device 170, as described above. A user may include any of the parties to the transaction, or may be a third party agent representing any or all of the transaction parties. For example, transaction manager 120 may be configured to receive a request to initiate the escrow transaction. The request may be initiated by any of the parties to the transaction, or by a third-party agent. The request may include information about the transaction parties such as the number of parties, (e.g., may include at least a first and second party), the role of the parties (e.g., funding party, such as buyer, and performing party, such as seller, service provider, etc.), contact information for each of the parties, funding information for each of the parties (e.g., wallet addresses for each of the parties), etc. The request may include information about the escrow transaction such as a name for the escrow transaction, the type of escrow funds involved in the escrow transaction (e.g., crypto currency, digital document, cryptographic key, etc.), the amount of escrow funds, terms of the transaction, the type of payment provided by the funding party, the type of payment desired to be received by the performing party, etc.

At block 201, the escrow transaction is created. In aspects, creating the escrow transaction may include extracting relevant data from the received transaction information, the relevant data including information for configuring a transaction smart contract, and/or information for monitoring and managing the transaction. In aspects, creating the escrow transaction may include identifying the terms of the transaction (e.g., the type of product or service being sold), and the type of funds to be escrowed (e.g., crypto currency, digital document, cryptographic key, etc.).

In aspects, creating the escrow transaction may include identifying the roles of the transaction parties based on the transaction information received at block 200. In aspects, identifying the roles of the parties may include identifying the role of each of the parties, or may include identifying which party is the funding party and which party is the performing party. In some embodiments, a third-party agent may be used and, in these cases, identifying the roles of the parties may include identifying the third-party agent. Creating the escrow transaction may also include identifying contact information for the transaction parties and notifying the transaction parties of the request to initiate the escrow transaction. In aspects, the funding party may be the user requesting to initiate the escrow transaction, in which case, the performing party, and optionally a third-party agent, may be notified of the escrow transaction request, and may be invited and provided with means to join the escrow transaction. In other aspects, the performing party may be the user initiating the escrow transaction, in which case the invitation may be sent to the funding party. In yet other aspects, the third-party agent may be the user initiating the escrow transaction, in which case the invitation may be sent to both the funding party and the performing party.

In some cases, the invited party or parties may agree or disagree with at least a portion of the information related to the proposed escrow transaction being created (e.g., the terms of the escrow transaction, the type of escrow funds, the amount of escrow funds, the type of product/service, etc.). In the case where the invited party or parties agree with the proposed escrow transaction, the escrow transaction may be created in accordance with the functionality described herein. In the cases where the invited party or parties disagree with the proposed escrow transaction, the invited party or parties may decline the invitation to join the escrow transaction. In aspects, the invitation may also include a means for the invited party to propose revisions to the proposed escrow transaction. In cases where the invited party proposes revisions, the inviting party, or, in the case where the inviting party is a third-party agent, the other transaction party, may review and either accept or decline the proposed revisions, or may propose further revisions. Thus, in this sense, transaction manager 120 may provide a means for negotiating the terms of an escrow transaction.

At block 202, a transaction smart contract associated with the escrow transaction may be configured. In aspects, configuring the transaction smart contract may include extracting relevant data from the received transaction information for configuring the transaction smart contract. The data for configuring the transaction smart contract may be saved/stored in a database, such as database 113 of FIG. 1, and may be marked in the database as information to be posted to a blockchain. In aspects, the relevant data for configuring the transaction smart contract may be based on a transaction smart contract template. The transaction smart contract template may define transaction details that may be combined, e.g., by smart contract generator 121, with a pre-defined smart contract logic to generate the transaction smart contract. For example, the transaction details may include the funding party's wallet address, the performing party's wallet address, the amount of escrow funds, and/or transaction terms set by the transaction parties. It is noted that the description of the exemplary transaction smart contract template is for illustrative purposes and should not be construed as limiting in any way. A transaction smart contract template in accordance with aspects of the present disclosure may include other and/or additional information related to the escrow transaction.

At block 203, transaction manager 120 causes the creation and deployment of the transaction smart contract. In aspects, creating and deploying the transaction smart contract may be performed by smart contract generator 121. Transaction manager 120 may cooperate with smart contract generator 121, such as by providing the configuration of the transaction smart contract to smart contract generator 121, to provide this functionality. It is noted that, in some embodiments, any of the functionality, or any portion of the functionality of smart contract generator 121 may be integrated into transaction manager 120, or the functionality of both transaction manager 120 and smart contract generator 121 may be provided in a single module.

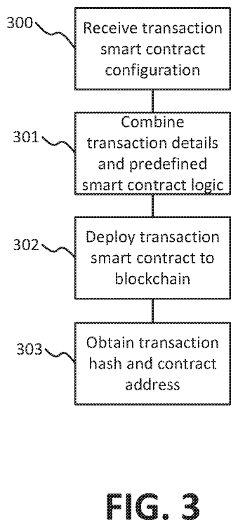

Thus, with reference back to FIG. 1, smart contract generator 121 may be configured to generate a transaction smart contract, and to deploy the transaction smart contract to a blockchain. The functionality of smart contract generator 121 will now be discussed with respect to the block diagram illustrated in FIG. 3. FIG. 3 shows a flow diagram illustrating functionality of smart contract generator 121 in accordance with aspects of the present disclosure. At block 300, transaction smart contract configuration information is received. In aspects, the configuration information for the transaction smart contract may include the configuration information generated by transaction manager 120 and may include relevant data to be included in the transaction smart contract.

At block 301, the transaction smart contract may be created. In aspects, creating the smart contract may include identifying a predefined smart contract logic based on the escrow transaction details, and combining the predefined smart contract logic with the transaction smart contract configuration information to generate the transaction smart contract. The smart contract logic may include executable and/or automatic logic to control particular aspects of the escrow transaction. For example, the smart contract logic may include logic to receive the escrow funds, such as digital property, to lock the funds within the smart contract, to determine a triggering event, and to dispose of the funds based on the triggering event. The smart contract logic may use the escrow transaction details to perform such functionality (e.g., the location of the funds to be escrowed, the amount of funds, the roles of the parties, etc.) of the transaction smart contract. In aspects, various predefined smart contract logics may be provided, and different smart contract logics may be configured to perform different functionality depending on the type of escrow transaction in which the smart contract logics may be used. For example, a first type of escrow transaction may use a first type of smart contract logic, where a second type of escrow transaction may use a second type of smart contract logic. In addition, the smart contract logic may depend on other details of the escrow transaction, such as the type of funds, the transaction parties, etc.

At block 302, the transaction smart contract may be deployed to a blockchain. For example, the transaction smart contract may be posted or submitted to a node of the blockchain. In aspects, the submission of the transaction smart contract to the blockchain may be performed by a backend server, and in this case, deploying the transaction smart contract to the blockchain may include smart contract generator 121 requesting the backend server to submit the transaction smart contract to the blockchain node. In some aspects, the deploying of the transaction smart contract may be in response to a user (e.g., the funding party, the performing party, the third-party agent, etc.) request to deploy the transaction smart contract to the blockchain. In other cases, the deploying of the transaction smart contract may be made automatically upon generation of the escrow transaction. As noted above, the blockchain platform to which the transaction smart contract may be deployed may include any blockchain platform suitable to host a smart contract, such as Ethereum, EOS, XRP, Bitcoin, and/or any other blockchain platform.

In aspects, at least a portion of the submission to the blockchain may be encrypted prior to being submitted to the blockchain. For example, certain parameters may be encrypted, such as to protect privacy. The encryption may be done using any of various encryption techniques, and may include using a private key. It is noted that the encryption of the submission may be optional, and may be dependent on the blockchain platform implementation. In aspects, the transaction smart contract may be marked as pending at this point.

At block 303, a transaction hash and a transaction smart contract address may be obtained. In aspects, upon submitting the transaction smart contract to a blockchain node, the blockchain node may generate a hash of the submission transaction, and may also generate an address associated with the transaction smart contract. In aspects, the transaction hash and the transaction smart contract address may be stored in the database, such as database 113, for reference. In particular, the transaction smart contract address may be used to fund the transaction smart contract, to indicate to the smart contract when terms of the escrow transactions have or have not been met, and to interact with the transaction smart contract. It is noted at this time that, in some implementations, interaction with the transaction smart contract may not be provided, and instead, the transaction smart contract may be configured to hold and release the funds without any external interaction.

At this time, the description of the functionality of transaction manager 120 is now continued with reference back to FIG. 2. At block 204, transaction manager 120 causes the transaction smart contract to be funded. In aspects, causing the transaction smart contract to be funded may include automatically transferring the escrow funds from the funding party's digital wallet, or from the location specified in the transaction information, to the transaction smart contract based on the transaction smart contract address. In some cases, transaction manager 120, in cooperation with GUI generator 122, may provide a user means for funding the transaction smart contract. For example, a GUI control element may be provided to the user via which the user may cause the transfer of funds from the funding party's wallet to the transaction smart contract address. In some implementations, the transaction smart contract address may be provided to the user via the GUI control elements, and the user may select, or manually input, the transaction smart contract address as the destination of the funds.

In some aspects, the transaction smart contract may be configured to accept funding from only the funding party identified in the escrow transaction details, from only the digital wallet identified in the escrow transaction details, and/or only in the amount specified in the transaction information, and to reject any funds originating from any other party, from any other source, and/or in any other amount. Thus, if the wallet address and/or the amount of funds specified in a funding request match the wallet address and the amount of funds specified in the transaction information, the funding request may be accepted, and the funds may be transferred from the wallet address to the transaction smart contract address. In aspects, upon successful funding of the transaction smart contract, the transaction smart contract may be marked as paid. When the wallet address and/or the amount of funds specified in a funding request do not match the wallet address and the amount of funds specified in the transaction information, the funding request may be denied and the transaction smart contract may not be funded.

In some aspects, the performing party may specify particular types of funds to receive. For example, the performing party may specify payment in the form of a first type of crypto currency. The funding party may specify a funding in the form of a second type of crypto currency, different from the first type of crypto currency. Thus, the funding party may be using a different type of payment than the payment desired to be received by the performing party. In this case, system 100 may also include functionality to exchange the type of payment provided by the funding party to the type of payment desired to be received by the performing party. For example, the second type of cryptocurrency may be exchanged to the first type of cryptocurrency. The exchange may be performed automatically, by transaction manager 120 interfacing with external exchange systems.

In aspects, as noted above, the smart contract logic of the transaction smart contract may be configured to lock the funds received within the smart contract until a triggering event is detected. In aspects, upon detection of a triggering event, the transaction smart contract may dispose of the funds based on the triggering event.

At block 205, the escrow transaction is monitored for a triggering event. As noted above, the transaction smart contract may be configured to lock the funds received within the smart contract until a triggering event is detected. In aspects, a triggering event may include full or partial performance of the terms of the escrow transaction, failure to meet the terms of the escrow transaction, contesting of the escrow transaction, expiration of a timer, an explicit trigger of the transaction smart contract, etc. In aspects, determining performance and non-performance may be done automatically by transaction manager 120, by the funding party, and/or by a third-party agent. For example, when the escrow transaction involves the sale of a product by a performing party to a funding party, the escrow transaction may be monitored for delivery of the product to the funding party. In aspects, the monitoring may be performed automatically by transaction manager 120, such as by analyzing available information to determine whether the product has been delivered to the funding party. Alternatively or additionally, the funding party may explicitly inform transaction manager 120 that the product has been delivered, such as by activating a GUI control via user device 170. In yet another example, a third-party agent may be used, in which case the third-party agent may determine that the product has been delivered to the funding party. The funding party may then inform transaction manager 120 that the product has been delivered to the funding party. In any case, the transaction manager 120 may determine that a triggering event, namely performance of the escrow transaction terms, has occurred. If instead, transaction manager 120 determines that the product was not delivered in accordance with the terms of the escrow transaction, for example the product was not delivered on time or was delivered with defects, transaction manager 120 may determine that the terms of the escrow transaction were not met. In some embodiments, the escrow transaction may include a timer that is started upon creation of the escrow transaction, upon deployment of the transaction smart contract, or upon successful funding of the transaction smart contract. In these cases, if no other triggering events occur by the time the timer expires, the expiration of the timer may be considered a triggering event. In other aspects, if the transaction smart contract is not funded within a certain period of time of the transaction smart contract deployment, a triggering event may be generated. In aspects, upon completion of the terms of the escrow transaction, the transaction smart contract may be marked as complete.

At block 206, the transaction smart contract may be triggered to dispose of the escrow funds based on the triggering event being triggered. The disposition of the escrow funds by the transaction smart contract may be triggered in response to the triggering event. In aspects, disposition of the escrow funds may include returning at least a portion of the escrow funds to the funding party, releasing at least a portion of the escrow funds to the performing party, and/or forwarding at least a portion of the escrow funds to a third-party agent and/or mediator, based on the triggering event. For example, in the case where the triggering event includes performance of the terms of the escrow transaction by the performing party, the escrow funds may be released to the performing party (e.g., to the digital address specified in the transaction details). In the case where the triggering event includes a failure to meet the terms of the escrow transaction by the performing party, the escrow funds may be returned to the funding party (e.g., to the digital address specified in the transaction details). In the case where the triggering event includes a partial performance of the terms of the escrow transaction by the performing party, a portion of the escrow funds (e.g., a portion corresponding to the portion of the terms performed by the performing party) may be released to the performing party, and a portion of the escrow funds (e.g., a portion corresponding to the portion of the terms not performed by the performing party) may be returned to the funding party. In the case where the escrow transaction is contested, such as by the funding party, the performing party, or a third-party agent, the escrow funds may remain locked within the transaction smart contract, or the escrow funds may be forwarded to a mediator (e.g., a digital address associated with the mediator). In aspects, the mediator may be the third-party agent. In these cases, the mediator may conduct mediation between the transaction parties to address the issues of contention and to determine how the escrow funds may be distributed. It is important to note that, in aspects, when the escrow funds are forwarded to a mediator, the functionality of system 100 may no longer be associated with the transaction, and the care of the escrow funds and distribution of the escrow funds in this case may be left to the mediator.

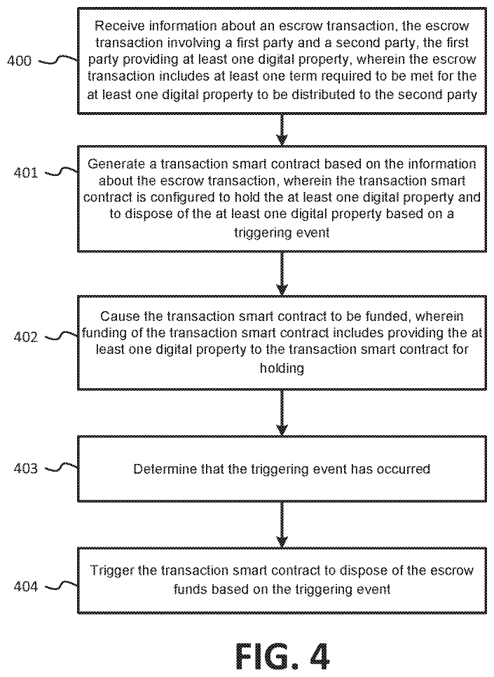

FIG. 4 shows a high level flow diagram of operation of a system configured in accordance with aspects of the present disclosure for configuring, creating, and deploying smart contracts to facilitate managing and execution of escrow transactions. The functions illustrated in the example blocks shown in FIG. 4 may be performed by system 100 of FIG. 1 according to embodiments herein. It is noted that the discussion that follows focuses on an example transaction involving a sale of a product by a performing party to a funding party. This example is used as a way of explanation and for illustrative purposes only, and should not be construed as limiting in any way. It will be appreciated that the operations and techniques discussed herein are equally applicable to situations where a system may be used for other types of escrow transactions, such as a peer-to-peer escrow transactions, business-to-customer escrow transactions, business-to-business escrow transactions, import or domestic letters of credit escrow transactions, export letters of credit escrow transactions, standby letters of credit escrow transactions, etc. In essence, the techniques described herein may be applied to any transaction in which a digital asset may be escrowed. It is also noted that although a third-party agent is described with respect to the example discussed, the use of the third-party agent is optional, and in some cases, a third-party agent is not used. In these cases, managing the escrow transaction and/or determining performance/non-performance may be done by the transaction parties or by the system of embodiments automatically.

At block 400, information about an escrow transaction may be received. In aspects, the escrow transaction may involve at least one funding part and at least one performing party. The funding party may be the party providing the funds, such as digital property, to be escrowed. The performing party may be the party to perform terms of the escrow transaction and who may receive the escrow funds after the terms of the escrow transaction have been determined to be met. For example, when the escrow transaction involves the sale of a product by a performing party to a funding party, information about the escrow sale may be received. In some cases, the escrow transaction may also involve a third-party agent representing the seller and/or the buyer, and the information may identify the third-party agent. In aspects, the information may be received from a user, via a GUI, such as the GUI generated by GUI generator 122 and provided to the user using user device 170. As noted above, the GUI may be provided to the user via a web interface, a standalone application, a mobile application, a plugin, etc., which the user may execute and/or open. For example, the user (e.g., the funding party, the performing party, the third-party agent, etc.) may log into the system using a username and password, and may initiate a request to create an escrow transaction.

Initiating the request may include activating a GUI control that allows the start of an escrow transaction. The user may then enter, using the GUI, information about the escrow transaction, such as a name for the escrow transaction, and the parties involved in the transaction (e.g., the funding party, the performing party, the third-party agent, etc.). The user may also enter information identifying the terms of the escrow transaction. For example, the user may specify (e.g., by entering the information or selecting it from a list or menu item) what the performing party is to sell, provide, or otherwise complete. In the example above, the user may select a type of product being sold by the performing party. The user may also select the type of escrow funds to be escrowed for the transaction. For example, the escrow funds may include a digital property that may include any of crypto currency, digital documents, cryptographic keys, etc. The user may then enter information specifying the roles of each party. For example, the user may identify the funding party as the buyer, the performing party as the seller, and, if a third-party agent is being used, the third party agent as a representative of either or both the buyer and seller and/or as a mediator.

In aspects, the user may also enter contact information about the transaction parties, such as an email address, telephone number, or other contact information for the buyer, and/or the seller. An invitation to join the escrow transaction may then be sent to the appropriate party based on the contact information. For example, where the user entering the information is the funding party, an invitation may be sent to the performing party to join the escrow transaction. In the case where the user entering the information is a third-party agent, the invitation may be sent to both the funding party and the performing party. The invitation may include information identifying the escrow transaction, and may also include information about the transaction, such as terms of the escrow transaction, type of escrow funds, amount of escrow funds, etc. For example, the invitation may specify that the performing party is to sell the product to the funding party in exchange for a particular amount of crypto currency. In another example, the invitation may specify that the performing party is to perform a service or an action in exchange for a particular digital document.

The invited party or parties may agree with the information in the invitation, in which case the invited party or parties may indicate acceptance of the invitation and thereby join the escrow transaction. However, the invited party or parties may disagree with at least a portion of the information in the invitation. For example, the invited party may disagree with the terms of the escrow transaction, the type of escrow funds, the amount of escrow funds to be paid, the type of product/service, etc. In this case, the invited party or parties may decline the invitation to join the escrow transaction. In aspects, the invitation may also include a means for the invited party to propose revisions to the proposed escrow transaction. Where the invited party makes revisions to the proposed escrow transaction, the invitation may be returned to the system, and the revised escrow transaction may then be sent to the other transaction parties, who may then either accept the revised escrow transaction, decline the revised escrow transactions, or propose further revisions to the escrow transaction. This mechanism allows the transaction party to negotiate the terms of the escrow transaction.

In aspects, upon acceptance of the proposed escrow transaction by all transaction parties, or their representatives, the escrow transaction may be generated. Further information about the transaction parties may be further entered into the system, based on information identifying the escrow transaction, such as an identification, which may be accessed via an escrow transaction details page. This further information may be entered by the respective party, or may be entered by a third-party agent. The further information may include a specifying digital addresses for the funding party and/or the performing party. In aspects, the digital address associated with the funding party may be an address where the escrow funds are kept, and from which the funds may be transferred to the transaction smart contract for holding. The digital address may be a digital wallet address, a, file path, or any other digital data source. The digital address associated with the performing party may be an address to where the escrow funds may be released upon performance of the terms of the escrow transaction. In a case where the escrow transaction involves the sale of a product, shipping information for the buyer may also be entered.

At block 401, a transaction smart contract is generated based on the information about the escrow transaction. In aspects, generating the transaction smart contract may include identifying and extracting relevant transaction data for configuring the transaction smart contract. The relevant data may include transaction details such as a digital address associated with the funding party, a digital address associated with the performing party, and an amount of funds to be escrowed. The transaction details may be combined with a predefined smart contract logic to generate the transaction smart contract. As noted above, the predefined smart contract logic selected to be combined may be based on the transaction details. In aspects, the transaction smart contract may be configured to hold the escrow funds until a triggering event may be detected, at which time the transaction smart contract may dispose of the escrow funds.

The generated transaction smart contract may be deployed to a blockchain node. In aspects, deploying the transaction smart contract to the blockchain node may be performed by a backend server, and the blockchain node may be part of a blockchain platform that may include any blockchain platform suitable to host a smart contract, such as Ethereum, EOS, XRP, Bitcoin, and/or any other blockchain platform. Upon successful submission of the transaction smart contract to the blockchain node, the transaction smart contract may be marked as pending. Submitting the transaction smart contract to the blockchain node results in a transaction hash and a transaction smart contract address being generated and obtained by the system. In some aspects, the transaction smart contract may be encrypted prior to being deployed to the blockchain using a private key.

At block 402, the transaction smart contract may be funded. In aspects, funding the transaction smart contract may include providing the escrow funds to the transaction smart contract for holding. In aspects, funding the transaction smart contract may include transferring the escrow funds from the digital address associated with the funding party to the transaction smart contract address obtained at block 401. In some implementations, the transferring of the escrow funds may be performed automatically. In other implantations, the funding party, or a representative of the funding party, may initiate the transfer, such as by manually entering or selecting from a list, using the GUI of embodiments, the transaction smart contract address as the destination of the transfer. In some embodiments, an interface to access the digital address of the funding party may be provided by the GUI to facilitate the funding party funding the transaction smart contract. For example, the digital address associated with the funding party may be a digital wallet account maintained by an external service provider. In this case, an interface to the external service provider, such as an interface allowing the funding party to enter login information, to access the digital wallet account, and to initiate and execute the transfer of the funds to the transaction smart contract may be provided. In some aspects, the funding party may manually access the digital wallet account at the external service provider to initiate the funding of the transaction smart contract.

As described above, the transaction smart contract may be configured to accept funding from only the funding party identified in the escrow transaction details, from only the digital wallet identified in the escrow transaction details, and/or only in the amount specified in the transaction information. The transaction smart contract may be configured to reject any funds originating from any party, from any source, and/or in any amount that does not match the respective information in the transaction information. In aspects, when the funding request is rejected, the escrow funds may be returned to the funding party. Upon successful funding of the transaction smart contract, the transaction smart contract may be marked as paid.

At block 403, the escrow transaction is monitored to determine whether a triggering event has occurred. In aspects, a triggering event may include a full or partial performance of the terms of the escrow transaction, a failure to meet all or any of the terms of the escrow transaction, contesting of the escrow transaction, expiration of a timer, an explicit trigger of the transaction smart contract, etc. In aspects, determining performance and non-performance may be done automatically by the system, or may be based on indications by the funding party, and/or by a third-party agent. For example, when the escrow transaction involves the sale of a product/service by the performing party to the funding party, the escrow transaction may be monitored for delivery of the product/service to the funding party. In this case, upon delivery of the product/service to the funding party, the funding party or the third-party agent, if the latter is used, may indicate the performance, which may generate a triggering event. If instead, the product/service is not delivered in accordance with the terms of the escrow transaction, a triggering event indicating non-performance may be generated. A timeout trigger event may be generated when no other triggering events have occurred upon the expiration of a timer. In other aspects, if the transaction smart contract is not funded within a certain period of time of the transaction smart contract deployment, a triggering event may be generated indicating a timeout. In aspects, the triggering event may indicate the event that caused the generation of the triggering event.

At block 404, the transaction smart contract is triggered to dispose of the escrow funds based on the triggering event. In aspects, triggering the transaction smart contract to dispose of the escrow funds based on the triggering event may include passing or sending the triggering event to the transaction smart contract. In other aspects, the trigger may be an indication to the transaction smart contract to dispose of the escrow funds. Disposition of the escrow funds may include returning at least a portion of the escrow funds to the funding party, releasing at least a portion of the escrow funds to the performing party, and/or forwarding at least a portion of the escrow funds to a third-party agent and/or mediator, based on the triggering event.

In aspects, the triggering event may indicate the event that caused the generation of the triggering event. Based on the event that caused the generation of the triggering event, the smart contract may dispose of the escrow funds. For example, when the triggering event indicates full performance of the terms of the escrow transaction by the performing party, the transaction smart contract may dispose of the escrow funds by releasing the escrow funds to the performing party (e.g., to the digital address specified in the transaction details). When the triggering event indicates a failure to meet the terms of the escrow transaction by the performing party, the transaction smart contract may dispose of the escrow funds by returning the escrow funds to the funding party (e.g., to the digital address specified in the transaction details). When the triggering event indicates a partial performance of the terms of the escrow transaction by the performing party, the transaction smart contract may dispose of the escrow funds by releasing a portion of the escrow funds (e.g., a portion corresponding to the portion of the terms performed by the performing party) to the performing party, and by returning a portion of the escrow funds (e.g., a portion corresponding to the portion of the terms not performed by the performing party) to the funding party. When the triggering event indicates that any portion of the escrow transaction may be contested, such as by the funding party, the performing party, or a third-party agent, the transaction smart contract may dispose of the escrow funds by forwarding the escrow funds to a mediator (e.g., a digital address associated with the mediator), or by maintaining the escrow funds locked within the transaction smart contract until the contest is resolved. In aspects, upon disposition of the escrow funds, the transaction smart contract may be marked as complete, and may refuse any further interactions.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

Functional blocks and modules in FIGS. 1-4 may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method comprising:
receiving information about an escrow transaction, the escrow transaction involving a first party and a second party, the first party providing at least one digital property, wherein the escrow transaction includes at least one term required to be met for the at least one digital property to be distributed to the second party;
generating a transaction smart contract based on the information about the escrow transaction, wherein the transaction smart contract is configured to:
hold the at least one digital property; and
dispose of the at least one digital property based on a triggering event;
causing the transaction smart contract to be funded, wherein funding of the transaction smart contract includes providing the at least one digital property to the transaction smart contract for holding;
determining that the triggering event has occurred; and
triggering the transaction smart contract to dispose of the at least one digital property based on the triggering event.

2. The method of claim 1, wherein the determining that the triggering event has occurred includes monitoring for performance of the at least one term of the escrow transaction.

3. The method of claim 2, wherein the triggering event triggers the transaction smart contract to dispose of the at least one digital property.

4. The method of claim 2, wherein the triggering event is at least one of: full performance by the second party of the at least one term, partial performance by the second party of the at least one term, failure by the second party to meet the at least one term, expiration of a timer, a contesting of the escrow transaction, and an explicit trigger of the transaction smart contract.

5. The method of claim 4, wherein disposition of the at least one digital property includes one or more of: returning at least a portion of the at least one digital property to the first party, distributing at least a portion of the at least one digital property to the second party, and forwarding at least a portion of the at least one digital property to a mediator.

6. The method of claim 5, wherein the triggering the transaction smart contract to dispose of the at least one digital property based on the full or partial performance by the second party of the at least one term includes triggering the transaction smart contract to distribute the at least a portion of the at least one digital property to the second party.

7. The method of claim 5, wherein the triggering the transaction smart contract to dispose of the at least one digital property based on the failure by the second party to meet the at least one term includes triggering the transaction smart contract to return the at least a portion of the at least one digital property to the first party.

8. The method of claim 5, wherein the triggering the transaction smart contract to dispose of the at least one digital property based on the contesting of the escrow transaction includes triggering the transaction smart contract to forward the at least a portion of the at least one digital property to the mediator.

9. The method of claim 2, wherein the triggering the transaction smart contract to dispose of the at least one digital property includes one of:
providing an indication to the transaction smart contract of the triggering event; and
automatically detecting, by the transaction smart contract, the triggering event.

10. The method of claim 1, wherein the at least one digital property includes at least one of: crypto currency, at least one digital file, and at least one cryptographic key.

11. A system comprising:
a transaction manager configured to:
receive information about an escrow transaction, the escrow transaction involving a first party and a second party, the first party providing at least one digital property, wherein the escrow transaction includes at least one term required to be met for the at least one digital property to be distributed to the second party;
cause the transaction smart contract to be funded, wherein funding the transaction smart contract includes providing the at least one digital property to the transaction smart contract for holding;
determine that a triggering event has occurred; and
trigger the transaction smart contract to dispose of the at least one digital property based on the triggering event; and
a smart contract generator configured to configure, based on the information about the escrow transaction, a transaction smart contract to:
hold the at least one digital property; and
dispose of the at least one digital property based on the triggering event.

12. The method of claim 11, wherein the triggering event is at least one of: full performance by the second party of the at least one term, partial performance by the second party of the at least one term, failure by the second party to meet the at least one term, expiration of a timer, a contesting of the escrow transaction, and an explicit trigger of the transaction smart contract.

13. The method of claim 12, wherein disposition of the at least one digital property includes one or more of: returning at least a portion of the at least one digital property to the first party, distributing at least a portion of the at least one digital property to the second party, and forwarding at least a portion of the at least one digital property to a mediator.

14. The method of claim 13, wherein the triggering the transaction smart contract to dispose of the at least one digital property based on the full or partial performance by the second party of the at least one term includes triggering the transaction smart contract to distribute the at least a portion of the at least one digital property to the second party.

15. The method of claim 13, wherein the triggering the transaction smart contract to dispose of the at least one digital property based on the failure by the second party to meet the at least one term includes triggering the transaction smart contract to return the at least a portion of the at least one digital property to the first party.

16. The method of claim 13, wherein the triggering the transaction smart contract to dispose of the at least one digital property based on the contesting of the escrow transaction includes triggering the transaction smart contract to forward the at least a portion of the at least one digital property to the mediator.

17. The method of claim 11, wherein the triggering the transaction smart contract to dispose of the at least one digital property includes one of:
providing an indication to the transaction smart contract of the triggering event; and
automatically detecting, by the transaction smart contract, the triggering event.

18. The method of claim 11, wherein the at least one digital property includes at least one of: crypto currency, at least one digital file, and at least one cryptographic key.

19. A computer-based tool including non-transitory computer readable media having stored thereon computer code which, when executed by a processor, causes a computing device to perform operations comprising:
receiving information about an escrow transaction, the escrow transaction involving a first party and a second party, the first party providing at least one digital property, wherein the escrow transaction includes at least one term required to be met for the at least one digital property to be distributed to the second party;
generating a transaction smart contract based on the information about the escrow transaction, wherein the transaction smart contract is configured to:
hold the at least one digital property; and
dispose of the at least one digital property based on a triggering event;
causing the transaction smart contract to be funded, wherein funding of the transaction smart contract includes providing the at least one digital property to the transaction smart contract for holding;
determining that the triggering event has occurred; and
triggering the transaction smart contract to dispose of the at least one digital property based on the triggering event.

20. The computer-based tool of claim 19, wherein disposition of the at least one digital property includes one or more of: returning at least a portion of the at least one digital property to the first party, distributing at least a portion of the at least one digital property to the second party, and forwarding at least a portion of the at least one digital property to a mediator.
